(19) United States
(12) Patent Application Publication
(10) Pub. No.: US 2003/0089442 A1
(43) Pub. Date: May 15, 2003

(54) FITER MATERIAL METHOD OF ITS MANUFACTE, AND APPARATUS FOR MANUFACTURING A FILTER MATERIAL

(76) Inventor: PETER PFEUFFER, KETSCH (DE)

Correspondence Address: KENYON & KENYON, ONE BROADWAY, NEW YORK, NY, 10004, US

(21) Appl. No.: 08/900,254

(22) Filed: Jul. 25, 1997

(30) Foreign Application Priority Data
Jul. 29, 1996 (JP) P 196 30522.5

(51) Int. Cl. B32B 17/00

(52) U.S. Cl. 156/62.2

(57) ABSTRACT

A method and apparatus for manufacturing a pleatable filter material from a thermally bonded non-woven fabric which has spacers, formed from the filter material itself, for folds. To produce the filter material, a fibrous web is formed from drawn and undrawn synthetic fibers and subsequently calendered. The fibrous web, which is not flat bonded, is bonded in a tension-free manner between profiled calender rolls without inhomogeneities over the cross-section of the non-woven fabric.

### BACKGROUND OF THE INVENTION

1. Field of the Invention

The present invention relates to a method for manufacturing a pleatable filter material from a thermally bonded, non-woven fabric. The filter material has spacers, formed from the filter material itself.

2. Description of the Prior Art

A method for making a filter material is shown in EP 0 429 805 B1. In that application, a flat filter medium is heated to its deformation temperature and gathered, transverse to the direction at which it is fed, by rollers, resulting in a grooving pattern. A filter medium aftertreated in this manner has the disadvantage that the grooves produced by gathering lose their form on the pleated filter element at relatively low operating is temperatures of 50 to 70° C.

Furthermore, synthetic non-woven fabrics are known on the market, for use as a pleatable filter media, in which parts of the non-woven fabric surface are bonded more strongly over the cross-section than the remainder of the non-woven fabric surface. A stiffening, three-dimensional structure results, which can be described as having spacers. The disadvantage of such media is that the local bondings result in perceptible inhomogeneities which negatively influence the separating properties of the entire filter medium.

### SUMMARY OF THE INVENTION

The object of the present invention is to develop a method of manufacturing a filter material such that spacers are produced without changing the homogeneity of the non-woven fabric. Another object of the present invention is to produce a filter material in which even under the influence of mechanical and/or thermal stresses during filtration, the spacers do not change their shape and remain stable during the entire service life.

To fulfill the objectives of the present invention, a fibrous web is first formed from drawn and undrawn (i.e., stretched and unstretched) synthetic fibers and subsequently calendered. To avoid essentially flat bonding, the fibrous web is bonded in a tension-free manner between profiled calender rolls without inhomogeneities over the cross-section of the non-woven fabric. The undrawn fibers, with their low melting point, serve as thermoplastic fibers. In this manner, a non-woven fabric is formed which has a high inherent stiffness necessary for pleating, and which, because of its already existing three-dimensional structure, has spacers for the folds produced later. These spacers remain stable even under the influence of mechanical and thermal stresses during the filtration operation.

In the method according to the present invention, it is advantageous that the finished filter medium, after the spacers have been impressed in the only calendering process, does not have to be heated again. Retractive forces within the filter material which can lead to an unwanted deformation of the spacers are prevented following the manufacture and during the entire service life of the filter insert.

The fibrous web of the present invention is directly calendered with a three-dimensional structure, without a detour using a flat calendering process, and during calendering is bonded.

In the filter medium produced by the method according to the present invention, the spacers are formed by elevations whose height corresponds to at least one quarter of the thickness of the filter material. The pronounced elevations are retained unchanged, without deformations, during the entire service life of the filter insert.

In addition, the present invention relates to a device for implementing the method named at the outset, and for manufacturing a filter material. The object underlying the present invention is to develop a device so that the spacers are produced without changing the homogeneity of the non-woven fabric, and that even under the influence of mechanical and/or thermal stresses during the filtration operation, they do not change their shape and remain stable during the entire service life.

The calender rolls—when viewed in cross-section—have an essentially sinusoidal surface profiling extending in the axial direction. The ratio of the height of the surface profiling in the radial direction and the axial width between adjacent vertices is preferably 0.1 to 0.2, the surface profiling being constructed in a manner that it is closed upon itself in the circumferential direction, i.e., extends around the entire circumference. Preferably, the calenders are made of steel and bring a line pressure of 20 to 60 bar, relative to a calender width of 1.2 m, on the fibrous web.

The calender rolls can be operated either cold, in the case of a preheated fibrous web, or hot with temperatures up to the melting point of the undrawn fibers, in the case of a fibrous web which is preheated or not preheated.

### BRIEF DESCRIPTION OF THE DRAWING

The drawings show an exemplary embodiment of a calender which is used in the device to implement the method of the present invention:

FIG. 1 is a side view of the calendering rolls; and

FIG. 2 is a detail cross-sectional view of the area X in FIG. 1.

### DETAILED DESCRIPTION OF THE INVENTION

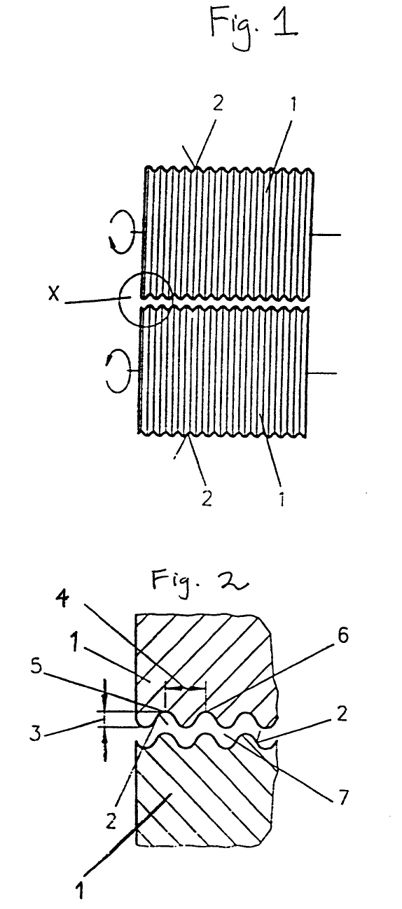

In FIG. 1, calender rolls 1 are shown, between which a fibrous web is passed for bonding, including bonding the spacers. Calender rolls 1 are heatable and/or coolable and —when viewed in cross-section (FIG. 2)—have an essentially sinusoidal surface profiling 2.

In FIG. 2, the details of the two calender rolls 1 are shown. The surface profiling 2 of the two calender rolls 1, viewed in cross-section, is sinusoidal, and the surface profilings are shaped congruently, so as to mate with one another. In this exemplary embodiment, the ratio of the height 3 of surface profilings 2 in the radial direction and the axial width 4 between adjacent vertices 5, 6 is between 0.1 and 0.2, and preferably 0.15. The gap 7 between the two calender rolls 1 is precisely adjustable to 0.1 mm constantly across the entire sinusoidal gap. The surface profiling 2 extends around an entire circumference of the calender rolls 1.

In the method of the present invention, a fibrous web is first formed from drawn and undrawn (i.e., stretched and unstretched) synthetic fibers and subsequently calendered between calender rolls 1. To avoid essentially flat bonding, the fibrous web is bonded in a tension-free manner between the profiled calender rolls 1 without inhomogeneities over the cross-section of the non-woven fabric. A non-woven fabric is formed which has a high inherent stiffness necessary for pleating, and which, because of its already existing three-dimensional structure, has spacers for the folds produced later. These spacers remain stable even under the influence of mechanical and thermal stresses during the filtration operation.

In the method according to the present invention, it is advantageous that the finished filter medium, after the spacers have been impressed in the calendering process between calender rolls 1, does not have to be heated again. Retractive forces within the filter material which can lead to an unwanted deformation of the spacers are prevented following the manufacture and during the entire service life of the filter insert.

The fibrous web of the present invention is directly calendered into a three-dimensional structure by surface profilings 2, without a detour using a flat calendering process, and thus bonded.

In the filter medium produced by the method according to the present invention, the spacers are formed by elevations whose height corresponds to at least one quarter of the thickness of the filter material, which elevation height corresponds to height 3. The pronounced elevations are retained unchanged, without deformations, during the entire service life of the filter insert.

I claim:

1. A method for manufacturing a pleatable filter material from a thermally bonded non-woven fabric, comprising the steps of:
forming a fibrous web from drawn and undrawn synthetic fibers;
calendering the fibrous web;
bonding the fibrous web in a tension-free manner between profiled calender rolls, without inhomogeneities over the cross-section of the non-woven fabric and without the use of flat bonding;
forming spacers in the filter material.

2. The method of claim 1, further comprising the step of:
preheating the fibrous web and then guiding the fibrous web between heated calender rolls.

3. The method of claim 1, further comprising the step of:
preheating the fibrous web and then guiding the fibrous web between cooled calender rolls.

4. The method of claim 1, further comprising the step of:
guiding the fibrous web, unheated, between heated calender rolls.

5. A filter material produced by the method comprising the steps of:
forming a fibrous web from drawn and undrawn synthetic fibers;
calendering the fibrous web;
bonding the fibrous web in a tension-free manner between profiled calender rolls, without inhomogeneities over the cross-section of the non-woven fabric and without the use of flat bonding;
forming spacers in the filter material.

6. The filter material of claim 5, wherein:
the spacers are formed by elevations in the calender rolls whose height is at least one quarter of a thickness of the filter material.

7. A device for producing a filter material comprising:
two calender rolls, each calendar roll comprising an essentially sinusoidal surface profiling extending in an axial direction of the calender rolls.

8. The device of claim 7, wherein:
the ratio of a height of the surface profiling in a radial direction of the calender rolls and the axial width between adjacent vertices of the surface profiling is 0.1 to 0.2, and wherein the surface profiling extends around an entire circumference of the calender rolls.
